(19) United States
(12) Patent Application Publication
(10) Pub. No.: US 2014/0214649 A1
(43) Pub. Date: Jul. 31, 2014

(54) PAY TO ANY ACCOUNT SERVICE

(71) Applicants: Brian J. DuCharme, New York, NY (US); Shawn Hagmeier, St. Peters, MO (US)

(72) Inventors: Brian J. DuCharme, New York, NY (US); Shawn Hagmeier, St. Peters, MO (US)

(21) Appl. No.: 13/750,515

(22) Filed: Jan. 25, 2013

(51) Int. Cl. G06Q 20/10

(52) U.S. Cl. CPC G06Q 20/10
USPC 705/39

(57) ABSTRACT

Example embodiments include methods and apparatus for making payments to any account utilizing an open-loop payment card system and a wholesale payment card account to pool funds destined for accounts which are not serviceable by the open-loop payment card system.

### TECHNICAL FIELD

Embodiments disclosed herein relate to payment systems. In particular, some embodiments relate to methods, apparatus, systems, and computer program products for leveraging an open-loop payment card system to transfer funds to accounts which are not included in the open-loop payment card system.

### BACKGROUND OF THE INVENTION

One type of payment system is a payment card system which is in widespread use. A prominent payment card system is operated by the assignee hereof, MasterCard International Incorporated (MasterCard), and by its member financial institutions. The MasterCard payment card system and similar systems are sometimes referred to as “open-loop” systems because transfers via the system may occur between two financial institutions (serving respective customers) that do not have a contractual relationship with each other but rather are members of the system. Thus transactions may travel within the system from an account at one FI (financial institution) via the system to an account at another FI, and not directly from one institution to the other. Accordingly, an open-loop system is “open” to any customer of any FI that is a member of the system. The open-loop payment card system utilizes an open-loop payment card network to connect the member FIs.

An example of a payment card network is Banknet©, a global telecommunications network operated by MasterCard, which is the foundation of a payments processing platform. Banknet is built as a virtual private network (VPN), and links hundreds of countries, thousands of customer financial institutions, and millions of merchants and cardholders worldwide. Banknet offers high reliability, speed and security, and fully scalable bandwidth to meet future demands. VPN technology creates private, virtual network paths, allowing transactions to travel on a fully protected and secure network for electronic payments.

Accounts in an open-loop payment card system are identified by a primary account number (PAN) that includes a bank identification number (BIN) field and customer account number field. The BIN identifies the bank that issued the payment card account to the customer and the primary account number identifies the payment card account of the particular customer at the identified bank.

Traditionally, payment card systems and other payment systems were used by consumers to pay for goods purchased from merchants. Recently, person-to-person (P2P) payment systems facilitating transfers of funds between accounts of individual persons have become prominent, especially in countries where many people do not have access to payment cards or banking services but do have access to portable devices such as mobile phones or network connected personal digital assistants (PDAs).

Many existing P2P payment systems are closed-loop systems which require users of the P2P payment system to be members of the system. In a closed-loop system, all customers in the system have accounts with a single payment services provider (which may be a bank, a mobile network operator (MNO) or a combination of banks and MNOs) or with a small number of cooperating payment money transfer organizations (MTOs). In these systems, purchase or payment transactions involve direct transfers between customers' accounts that are issued by the payment services provider.

In many instances a MNO will partner with a financial institution (FI) such as a bank to implement the closed-loop P2P payment system. Thus, payment from a payer to a payee using a closed-loop P2P payment system is only possible if both parties have an account with the P2P payment system.

There also exist P2P payment systems that use the existing open-loop payment system to transfer funds from an authorized account, such as a savings or checking account, to a payment card account. However, such systems, for example the MoneySend system implemented by MasterCard, are not able to transfer funds to non-payment card accounts.

While open-loop payment systems are a prevailing mode of handling payment card transactions in the United States and other highly developed countries, closed-loop payment systems may also play a role in those countries, and are often quite important in less developed countries. Heretofore, payment systems have not supported transfers between accounts of different closed-loop payment system accounts.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and example embodiments and which are not necessarily drawn to scale, wherein:

FIG. 1 is a block diagram that illustrates an existing open-loop payment card network.

FIG. 2 is a block diagram of an example embodiment.

FIG. 3 is a flow diagram of an example embodiment.

FIG. 4 is a block diagram that illustrates an example embodiment of an originating institution server computer that may be part of the system of FIG. 2.

FIG. 5 is a block diagram that illustrates an embodiment of a receiving institution server computer that may be part of the system of FIG. 2.

### OVERVIEW

In an example embodiment an originating institution prepares a payment message including a primary account number identifying a wholesale payment card account and a non-payment card destination account identifier, with the non-payment card destination account identifier identifying a non-payment card account to which a payment is to be made. The originating institution sends the payment message to a receiving institution using an open-loop payment card network. The open-loop payment card system is configured to transfer payments only to payment card accounts and the non-payment card destination account identifier is configured to facilitate transfer, at the receiving institution, of the payment from the wholesale payment card account to a non-payment card account identified by the non-payment card destination account identifier.

The receiving institution receives the payment message sent from the originating institution using the open-loop payment card network. The payment amount indicated in the open-loop network message is transferred to the wholesale payment card account held by the receiving institution. The receiving institution credits the same amount to the non-payment card destination account for benefit of the receiving consumer

In one example embodiment the receiving institution transfers the payment amount from the wholesale payment card account to a closed-loop payment system account using a web services application program interface (API).

The use of the wholesale payment card account facilitates settlement of funds between banks and their service partners for any type of funding or payment instruments such as non-payment card financial instruments including, but not limited to, other accounts held by the bank such as Demand Deposit and Savings Accounts, mobile money accounts held by telephone companies (Telcos) and payments into Money Transfer Organizations (MTOs) to be picked up in cash by a receiver.

The wholesale payment card account also facilitates funding from any source including cash, demand deposits accounts and mobile money accounts from a Telco or MTO partner. Further, a bank can use the same settlement process with the open-loop payment card system to settle payment to multiple types of non-payment card destination accounts.

The wholesale payment card account also facilitates transfers between accounts held by different banks in countries not having automatic clearing house (ACH) services. In these countries funds must be physically transferred between accounts held by different banks.

Other features and advantages will be apparent in view of the following detailed description.

### DETAILED DESCRIPTION OF EXAMPLE EMBODIMENTS

In general, and for the purpose of introducing concepts of embodiments of the present invention, a pay-to-any-account service provides a system for leveraging the benefits of an open-loop payment system to transfer money between accounts that are not linked to the open-loop system.

In an example transaction, a customer does not have a payment card but is enrolled in a closed-loop P2P payment system with her MNO and wishes to share expenses with a friend who does have a payment card. The friend uses her payment card to pay the expense and the customer pays her share by making a payment to the friend using the P2P service.

The customer opens a P2P application on the customer's mobile device and enters a P2P identifier of the friend onto a field provided by the P2P application displayed on the customer's mobile device. This identifier could be the friend's mobile phone number or some other type of identifier.

The P2P identity of the friend is transmitted using standard wireless technology to the originating institution of the pay to any account system which then maps the P2P identity into a destination account number of the friend. For example, if the P2P identity were the mobile phone number of the friend, the originating institution would use the phone number to search a database to find the primary account number (PAN) of the wholesale payment card account. This PAN would include the BIN which identifies the receiving institution holding the destination account.

A message is then sent from the originating institution to the receiving institution using the open-loop payment card network. The message includes the destination account identifier and the PAN of a wholesale payment card account held by the receiving institution and used to pool payments received from the open-loop payment card network. The receiving institution moves the received payment from wholesale payment card account to the destination account.

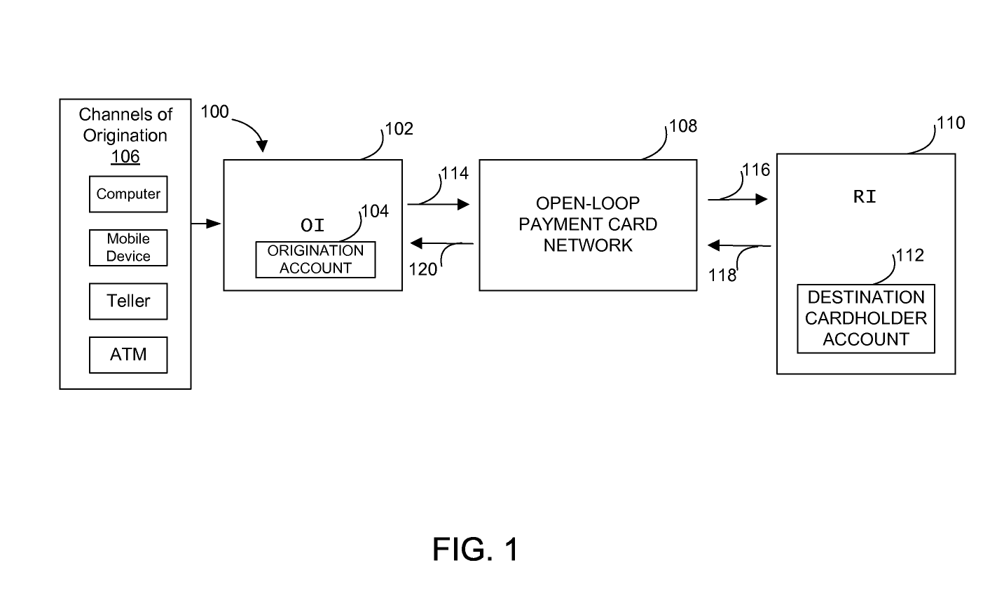

FIG. 1 depicts an existing system, such as MoneySend, that transfers funds between an authorized non-payment card account at an originating institution to a payment card account held at a receiving institution.

In FIG. 1 the various blocks depicted are part of a larger system 100 that includes an originating institution (OI) 102 having an origination account 104 and channels of origination 106 including customer interfaces such as a computer, a portable device, face-to-face interaction with a teller, and an ATM, an open-loop payment card network 108, and a receiving institution 110 having a destination payment card account 112.

In operation, a channel of origination receives transaction information from a customer including, for example, an indication of an origination account from which funds are to be transferred and an indication of a destination account to which funds are to be transferred. In this example the indication of the destination account is the PAN of the destination payment card account.

If the channel of origination is a mobile device then the mobile device will utilize an application provided by the OI or other payment service, such as an MNO, to display a user interface on the portable device to allow the customer to enter the required payment information. The payment information will be transmitted to the OI using standard wireless technology.

The OI 102 sends a transaction message to the RI 110 including the PAN and the amount to be transferred to the destination payment card account. The transaction request is routed via the open-loop payment card network 108 (which may be, for example, the above-described Banknet system) to the issuer RI 110 that holds the destination payment card account 112. Arrows 114, 116, 118 and 120 trace the communication paths between the OI 102 and the RI 110 via the open-loop payment card network 108.

A subsequent clearing transaction results in a transfer of the transaction amount from the origination account 104 to the destination account 112.

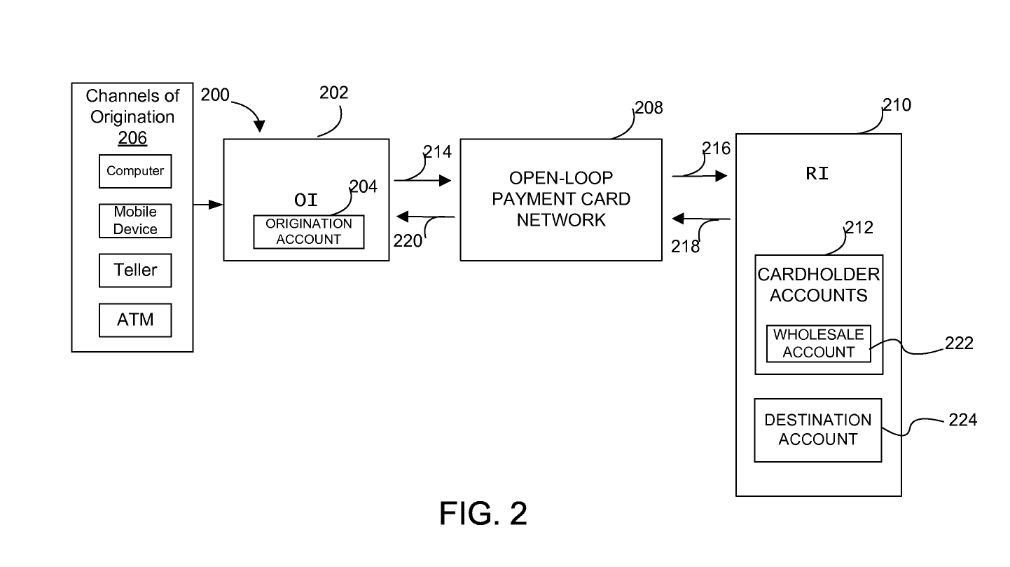

FIG. 2 depicts an example embodiment that facilitates payment to any non-payment card account. Blocks in FIG. 2 that are the same or similar to blocks in FIG. 1 are corresponding reference numerals.

In FIG. 2 the RI 210 holds a special payment card account called a wholesale payment card account 222 which is a payment card account used by the RI to pool funds received from the OI that are destined for a non-payment card destination account 224. In this example, the destination account 224 is depicted as held at the RI 210. As described more fully below, the RI may have an interface, such as a web services API, for transferring the payment to a destination account not held at the RI.

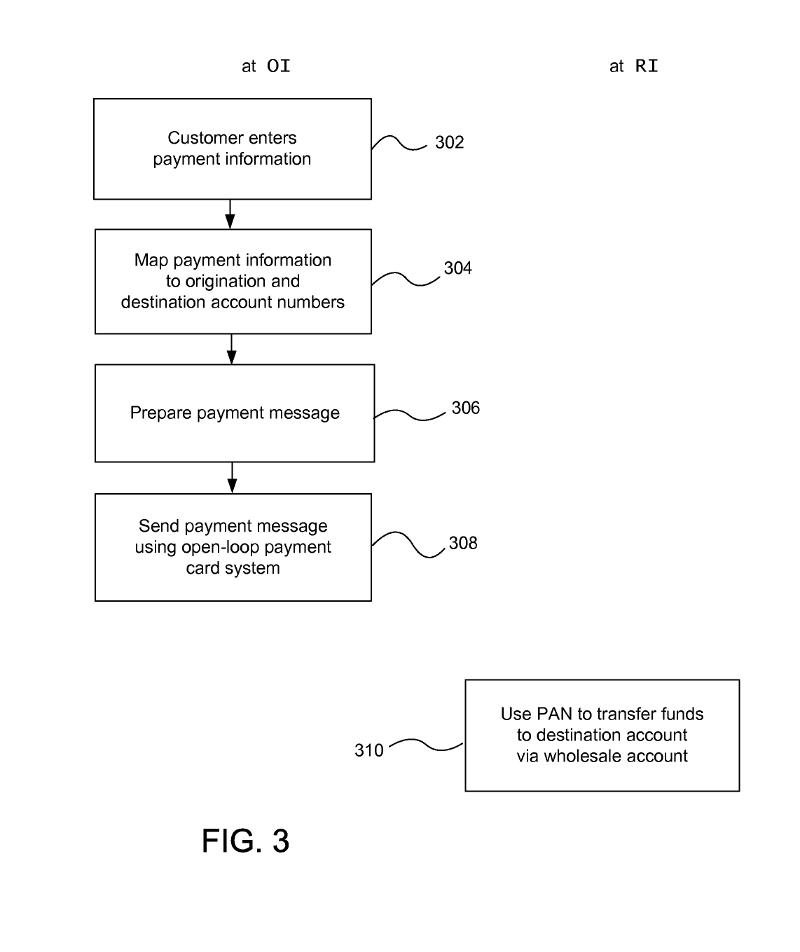

The wholesale payment card account 222 is not assigned to a particular payment card and its function will now be described with reference to the flow chart of FIG. 3.

FIG. 3 depicts the process steps for leveraging the existing technology for transferring funds only to payment card accounts, as depicted in FIG. 1, to transferring funds to any account, as depicted in FIG. 2.

In process step 302, a sender (payer) enters payment information identifying a destination account using one of the channels of origination 206 of the OI 202. In this example it is assumed that the destination account is not a payment card account. The payment information entered could be a telephone number of a payee, a checking account number, a savings account number, a payment account number of a closed-loop P2P service provider such as a Telco or MNO that partners with the OI, etc.

For example, the sender may go to an MTO and want to pay for a P2P payment with HER bank account. The Sender provides her bank account rtn/transit number to the MTO and the MTO looks up the Wholesale Account Number by the RTN number and locates the Wholesale Account Number. In this case, the MTO submits a purchase transaction using the Wholesale Account Number and provides the sender's account details to the OI. This allows the MTO to use the card network to immediately pull funds from the sender's bank account to fund the money transfer.

In one example embodiment, a cash payment to the recipient is facilitated by transferring a unique transaction ID from a destination MTO holding the destination account to the OI in a response message 218 and 220. The OI provides the sender with the unique transaction ID and the sender may then call the recipient to transfer the unique transaction ID which can be used by the recipient to obtain cash from the destination MTO.

Proceeding to process step 304, the OI 202 processes the payment information, received via channels of origination 206, to identify the origination account and the destination account. This processing may require the use of a database. For example, the database could be searched using the payer's telephone number to identify the originating account and by the payee's telephone number to identify the destination account. If the RI is a bank then the identification of the destination account would include the BIN as part of the wholesale account number of the RI.

Proceeding to process step 306, the OI 202 debits the originating account by the amount of the transaction and prepares a payment message to be sent to the RI 210. The payment message includes the PAN of the wholesale account, the identification of the non-payment card destination account and the payment amount. The payment message is formatted for processing by the open-loop payment card network 208.

The payment message 214 and 216 may include the PAN of the wholesale account, the identification of the non-payment card destination account and the payment amount to be delivered in a batch file or may be part of a message sent via an API call to the RI 210.

Proceeding to process step 308, the payment message is transferred to the open loop payment system. The open-loop payment card network 208 uses the PAN in the payment message to route the message to the correct RI.

Proceeding to process step 310, the RI 210 processes the payment message provided by the open-loop payment card network 208 to transfer the payment amount specified in the payment message to the destination account 224 via the wholesale payment card account 222. This step can be considered as a transfer of the payment amount to the wholesale payment card account specified by the PAN included in the payment message using the existing technology described in FIG. 1 and then transferring the payment amount from the wholesale payment card account 222 to the destination account 224. The OI and RI book the transfer as a general ledger entry from the origination account 204 to the destination account 224.

As described above, in some example embodiments, the destination account is not held in a financial institution. For example, a payee using an MTO service retrieves funds from the local agent of the MTO. In this example, the RI would move funds to the MTO's bank account from the wholesale payment card account via a prescribed set of API network service calls where the MTO provides the prescribed set of API network service calls.

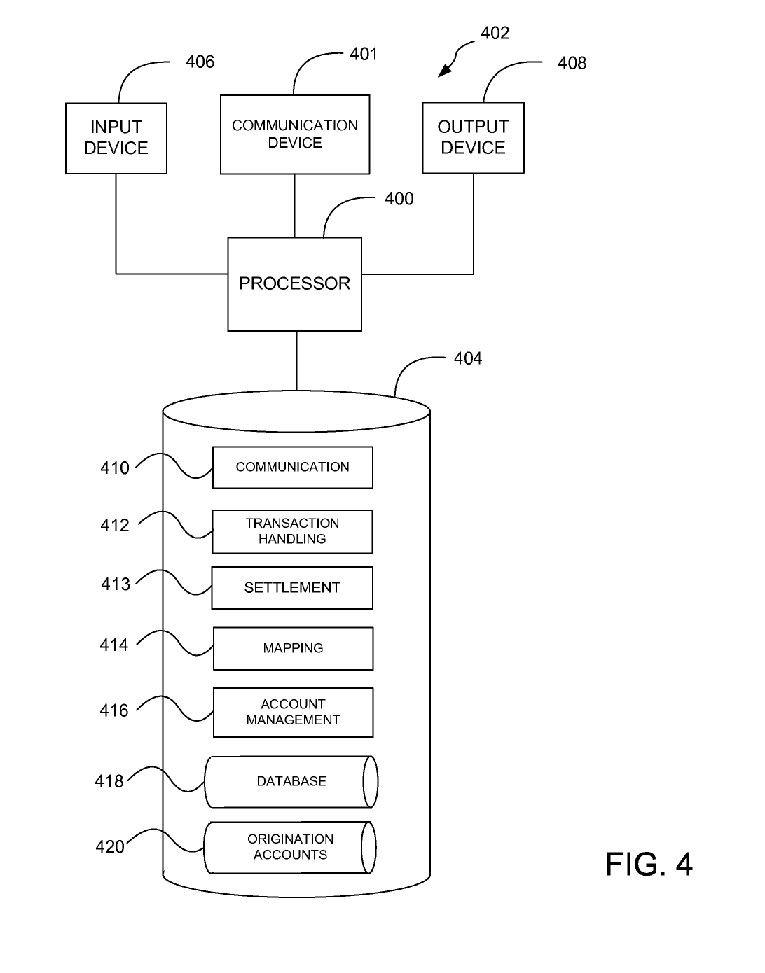

FIG. 4 is a block diagram representation of a computer 302 which may perform some or all of the data processing functions to implement the pay-to-any-account process at the OI 102. Accordingly, the computer depicted in FIG. 4 may be referred to as the “OI pay-to-any-account” computer.

The OI pay-to-any-account computer 402 may be conventional in its hardware aspects but may be controlled by software to cause it to operate in accordance with aspects of the present invention.

The pay-to-any-account computer 402 may include a computer processor 400 operatively coupled to a communication device 401, a storage device 404, an input device 406 and an output device 408.

The computer processor 400 may be constituted by one or more conventional processors. Processor 400 operates to execute processor-executable steps, contained in program instructions described below, so as to control the pay-to-any-account computer 402 to provide desired functionality.

Communication device 401 may be used to facilitate communication with, for example, other devices (such as one or more computers that constitute the open-loop payment card system 208 (FIG. 2) or wireless mobile devices. Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

Storage device 404 stores one or more programs for controlling processor 400. The programs comprise program instructions that contain processor-executable process steps of pay-to-any-account computer 402, including, in some cases, process steps that constitute processes provided in accordance with principles of the present invention, as described in more detail below.

The programs may include a communication application 410 for communicating with wireless devices and P2P service providers as described more fully below.

The programs may include an transaction handling application 412 that is for handling individual transactions as described herein and a settlement application 413 used for settlement of funds transfer between different accounts. Details of operation of the transaction handling application 412 are discussed above, particularly with reference to FIGS. 2 and 3. The programs stored on the storage device 404 may further include an account management application 416. The application may manage accounts, including opening and closing of accounts, and overseeing whether the accounts are maintained in good standing

The storage device 404 may also store an application 414 for mapping customer identifiers (e.g., customer telephone numbers or other non-standard account identifiers) into formats that can be used by the open-loop payment card network 108.

Reference numeral 418 in FIG. 4 identifies one or more databases that are maintained by the pay-to-any-account computer 402 on the storage device 404. Among these databases may be a consumer account holder database and a transaction database.

The storage device 404 may also store data required for operation of the pay-to-any-account computer 402, including data 420 regarding origination account 204. As described above, the origination account is not required to be held by the OI. The data held in the origination accounts database can also include data used by the communication device to access accounts such as accounts held by a Telco or MNO partner of the OI.

The application programs of the OI pay-to-any-account computer 402, as described above, may be combined in some embodiments, as convenient, into one, two or more application programs. Moreover, the storage device 404 may store other programs, such as one or more operating systems, device drivers, database management software, web hosting software, etc.

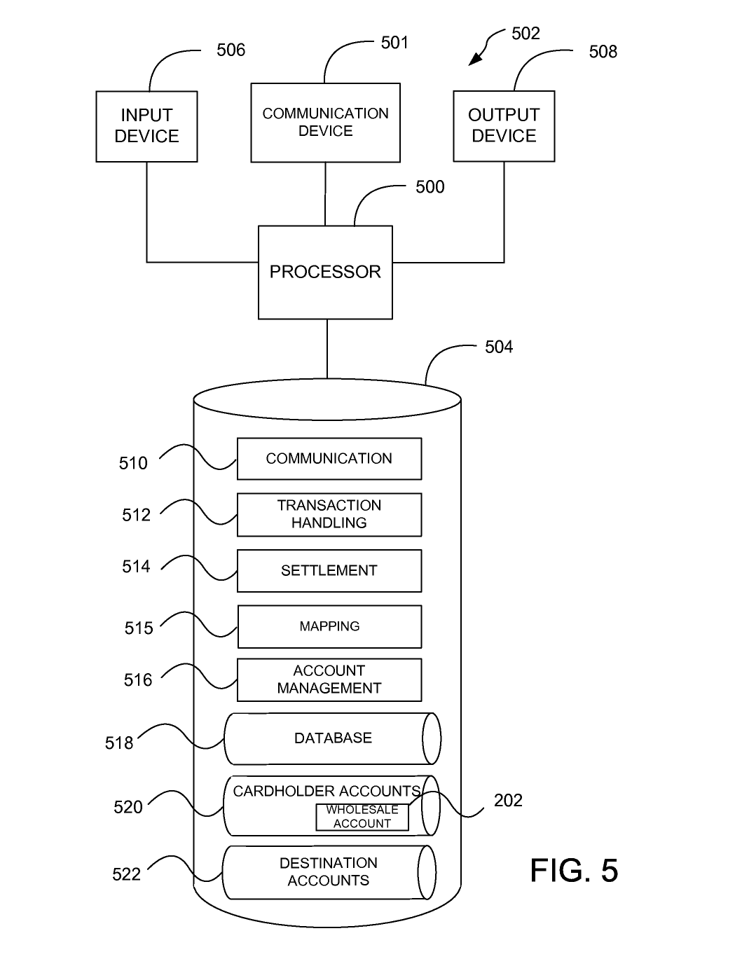

FIG. 5 is a block diagram representation of a computer 502 which may perform some or all of the data processing functions to implement the pay-to-any-account process at the RI 110. Accordingly, the computer depicted in FIG. 5 may be referred to as the “RI pay-to-any-account” computer.

The RI pay-to-any-account computer may be implemented by one or more computers coupled by a network where data and program code may be stored an any of the computers and where processing may take place in distributed manner among the computers coupled to the network.

The RI pay-to-any-account computer 502 may be conventional in its hardware aspects but may be controlled by software to cause it to operate in accordance with aspects of the present invention.

The pay-to-any-account computer 502 may include a computer processor 500 operatively coupled to a communication device 501, a storage device 504, an input device 506 and an output device 508.

The computer processor 500 may be constituted by one or more conventional processors. Processor 500 operates to execute processor-executable steps, contained in program instructions described below, so as to control the pay-to-any-account computer 502 to provide desired functionality.

Communication device 501 may be used to facilitate communication with, for example, other devices (such as one or more computers that constitute the open-loop payment card network 208 (FIG. 2) or wireless mobile devices. Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

Storage device 504 stores one or more programs for controlling processor 500. The programs comprise program instructions that contain processor-executable process steps of pay-to-any-account computer 502, including, in some cases, process steps that constitute processes provided in accordance with principles of the present invention, as described in more detail below.

The programs may include a communication application 510 for communicating with wireless devices and P2P service providers as described more fully below.

The programs may include an RI transaction handling application 512 that is for handling individual transactions as described herein and a settlement application 514 used for settlement of funds transfer between different accounts. Details of operation of the transaction handling application 512 will be discussed below, particularly with reference to FIGS. 2 and 5.

The storage device 504 may also store an application 515 for mapping customer identifiers (e.g., customer telephone numbers or other non-standard account identifiers) into formats that can be used by the open-loop payment card network 108.

The programs stored on the storage device 504 may further include an account management application 516. The application may manage accounts, including opening and closing of accounts, and overseeing whether the accounts are maintained in good standing

Reference numeral 518 in FIG. 5 identifies one or more databases that are maintained by the pay-to-any-account computer 502 on the storage device 504. Among these databases may be a consumer account holder database and a transaction database.

The storage device 504 may also store data required for operation of the pay-to-any-account computer 502, including data 520 regarding payment card accounts (including the wholesale payment card account 222) and data 522 relating to destination accounts.

The application programs of the pay-to-any-account computer 502, as described above, may be combined in some embodiments, as convenient, into one, two or more application programs. Moreover, the storage device 504 may store other programs, such as one or more operating systems, device drivers, database management software, web hosting software, etc.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable.

As used herein and in the appended claims, the term “payment card account” includes a credit card account or a deposit account that the account holder may access using a debit card. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method performed by one or more processors at an originating institution comprising:
preparing, using computer, a payment message including a primary account number identifying a wholesale payment card account and a non-payment card destination account identifier, with the non-payment card destination account identifier identifying a non-payment card destination account to which a payment is to be made; and
sending the payment message to a receiving institution over an open-loop payment card network, using the computer, with the open-loop payment card network configured to transfer a payment only to payment card accounts and with the non-payment card destination account identifier configured to facilitate transfer, at the receiving institution, of the payment from the wholesale payment card account to the non-payment card destination account identified by the non-payment card destination account identifier.

2. The method of claim 1 further comprising:
receiving information indicating the destination account identifier from a channel of origination.

3. The method of claim 1 where the channel of origination is a money transfer organization (MTO).

4. The method of claim 3 further comprising:
receiving an MTO transaction ID from the receiving institution; and
providing the transaction ID to a payee.

5. An origination computer comprising:
one or more memory devices;
an interface to an open loop payment card system;
one or more processors configured to perform the steps of:
preparing a payment message including a primary account number identifying a wholesale payment card account and a non-payment card destination account identifier, with the non-payment card destination account identifier identifying a non-payment card destination account to which a payment is to be made; and
sending the payment message to a receiving institution over the open-loop payment card network, with the open-loop payment card network configured to transfer a payment only to payment card accounts and with the non-payment card destination account identifier configured to facilitate transfer, at the receiving institution, of the payment from the wholesale payment card account to the non-payment card destination account identified by the non-payment card destination account identifier.

6. The origination computer of claim 5 further comprising:
channels of origination configured to receive information indicating the destination account identifier.

7. The origination computer of claim 6 where a channel of origination is a money transfer organization (MTO).

8. The origination computer of claim 7 further with the one or more processors further configured to perform the steps of:
receiving an MTO transaction ID from the receiving institution; and
providing the transaction ID to a payee.

9. A method performed by a computer at a receiving institution, where the receiving institution maintains a wholesale payment card account utilized to pool payments destined for non-payment card destination accounts, the method comprising:
receiving a payment message sent from an originating institution over an open-loop payment card network, with the payment message including a primary account number identifying the wholesale payment card account and a non-payment card destination account identifier, with non-payment card destination account identifier identifying a non-payment card destination account to which a payment is to be made and with the open-loop payment card network configured to transfer a payment only to payment card accounts and with the non-payment card destination account identifier configured to facilitate transfer, at the receiving institution, of the payment from the wholesale payment card account to the non-payment card destination account;
crediting a payment amount, using the computer, indicated by a received payment message, to the wholesale payment card account; and
transferring, using the computer, the payment amount from the wholesale payment card account to a non-payment card destination account.

10. The method of claim 9 with transferring the payment amount further comprising:
transferring, using the computer, the payment amount from the wholesale payment card account to a destination closed-loop payment system account using a web services application program interface (API) provided by the destination closed-loop payment system.

11. The method of claim 10 where the closed-loop payment system account is an account held by a money transfer organization (MTO).

12. The method of claim 11 further comprising:
receiving an MTO transaction ID from the MTO; and
transmitting, using the computer, the MTO transaction to the originating institution.

13. A destination computer:
one or more memory devices;
an interface to an open loop payment card system;
one or more processors configured to perform the steps of:
receiving a payment message sent from an originating institution over the open-loop payment card network, with the payment message including a primary account number identifying the wholesale payment card account and a non-payment card destination account identifier, with non-payment card destination account identifier identifying a non-payment card destination account to which a payment is to be made and with the open-loop payment card network configured to only transfer a payment to payment card accounts and with the non-payment card destination account identifier configured to facilitate transfer, at the receiving institution, of the payment from the wholesale payment card account to the non-payment card destination account;
crediting a payment amount, indicated by a received payment message, to the wholesale payment card account; and
transferring the payment amount from the wholesale payment card account to a non-payment card destination account.

14. The destination computer of claim 13 further comprising:
an interface to closed-loop payment system; and
with the one or more processors configured to perform the step transferring the payment amount further configured to perform the step of:
transferring the payment amount from the wholesale payment card account to a destination closed-loop payment system account using a web services application program interface (API) provided by the destination closed-loop payment system.

15. The destination computer of claim 14 where the closed-loop payment system account is an account held by a money transfer organization (MTO).

16. The destination computer of claim 15 with the one or more processors further configured to perform the steps of:
receiving an MTO transaction ID from the MTO; and
transmitting the MTO transaction to the originating institution.

17. The destination computer of claim 13 where the destination account is stored in the one or more memory devices.
